(19) United States
(12) Patent Application Publication
(10) Pub. No.: US 2010/0110464 A1
(43) Pub. Date: May 6, 2010

(54) MULTI-FUNCTION PERIPHERAL DEVICE WITH SCANNING CUSTOMIZATION

(75) Inventors: Constantinos Kardamilas, Irvine, CA (US); Mark Van Regenmorter, Irvine, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/262,483

(22) Filed: Oct. 31, 2008

(51) Int. Cl. G06F 3/12; H04N 1/04; G06F 15/00

(52) U.S. Cl. 358/1.13; 358/474; 358/1.9

(57) ABSTRACT

An MFP device that is capable of scanning a document and displaying to the user a plurality of options whereby the user can modify the scanned image using the MFP controls. The options can be displayed to the user either via a display or by printing a document with the various options for the user to select graphically and the re-scan the document so as to provide the selection to the MFP device.

### BACKGROUND OF THE INVENTION

1. Field of the Invention

The present invention relates to multi-function peripheral devices and, in particular, concerns a multi-function peripheral device that permits a user to adjust various parameters of a scanned document using inputs or functionality of the multi-functional peripheral device.

2. Description of the Related Art

Multi-function peripheral devices (MFP) are devices that are commonly used in conjunction with computer networks. The typical MFP includes the functionality of printing, scanning, and copying. MFP's may also include communication-type functionalities such that documents can be transmitted with the MFP via fax, internet or other protocols. In one particular implementation, documents can be scanned into the MFP and the documents can then be routed either via email or fax or some other communication protocol to a desired email destination.

While MFPs are very useful tools for processing documents, in some circumstances, the use of MFPs is somewhat cumbersome. For example, when a document is scanned, a physical embodiment of the document is captured in an electronic format. Generally, the user then instructs the scanner to where to send the electronic representation of the scanned document. Oftentimes, the user will wish to format the scanned document prior to sending it to its final destination. As an example, if an individual is scanning a document to be sent to another person, the individual may wish to modify certain aspects of the document prior to sending it to the other person.

Presently, the only way that a user can modify an electronic version of a document prior to transmitting the document to another destination, is to send the electronic version of the document to a computer that the user has access to. The user then uses dedicated software on the computer to manipulate the scanned document into the format that the user so desires. Only upon completing this process can the user than transmit the scanned document onto another destination in the format that is desired by the user.

Hence, typical MFPs require the user to make use of an additional piece of equipment, the additional computer, in order to process a scanned document. This results in delays in transmitting documents and can also be somewhat tiresome for the user particularly when the format changes in the scanned document the user seeks to implement are relatively simple.

Hence, there is a need for a simplified process whereby individuals scanning documents can modify the scanned documents without requiring the individual to have the scanned document forwarded to another computer system prior to transmitting the document to it intended final destination.

### SUMMARY OF THE INVENTION

The aforementioned needs are satisfied, in one implementation, by an MFP which incorporates a scanner. The MFP further incorporates a display and a plurality of user inputs. The MFP further includes a processor that is adapted to review the scanned version of the document and to recognize various components of the document. The processor is further configured to present options to the individual as to how to modify the display of the different components of the scanned document. The MFP is then configured to allow the user to provide instructions to the MFP to allow the MFP to modify the documents in accordance with the user's selections. Subsequently, the MFP can optionally display the modified document and can then further transmit the modified document to a desired destination.

In one implementation, the MFP is adapted to display the options for modifying the various components of the document to the user by printing a page via a printer which has written indications as to the various modification options available to the user. The user then graphically selects the desired option, e.g., by marking the desired option, and rescans the printed page using the scanning functionality of the MFP. The processor then reviews the graphic selections and modifies the electronically stored version of the scanned document according to the user's selections. In this way, an MFP with a limited display capability can be configured to allow a user to modify a scanned document using the MFP.

In another adaptation, the MFP includes a display and the modification options available to the user for the different components of the scanned documents that will be provided to the user via the display. The user can then select desired options using the user inputs off the MFP.

It will be appreciated that, by permitting the user to modify the electronic version of the document via the MFP itself, the user will be better able to modify electronic versions of scanned documents without having to resort to using additional computer systems. These and other objects and advantages of the present invention will become more apparent from the following description taken in conjunction with the accompanying drawings.

### BRIEF DESCRIPTION OF THE DRAWINGS

FIG. 1A is a simplified schematic representation of one embodiment of a multi-function peripheral device (MFP);

FIG. 1B is a simplified block diagram of the multi-function peripheral device of FIG. 1A;

FIG. 2 is a simplified flow chart illustrating a process by which the MFP of FIGS. 1A and 1B will scan a particular document and allow the user to modify the electronic version of the scanned document via a control associated with the MFP;

FIGS. 3A and 3B are exemplary flow charts illustrating two possible manners in which the MFP displays to the user various modification options;

FIGS. 4A-4C are exemplary processes by which the MFP 102 may display various modification options to the user relating to a particular document; and

FIGS. 5A-5C are the resulting document of FIGS. 4A-4C after the MFP has modified the document in accordance with the modification options selected by the user.

### DETAILED DESCRIPTION OF THE PREFERRED EMBODIMENT

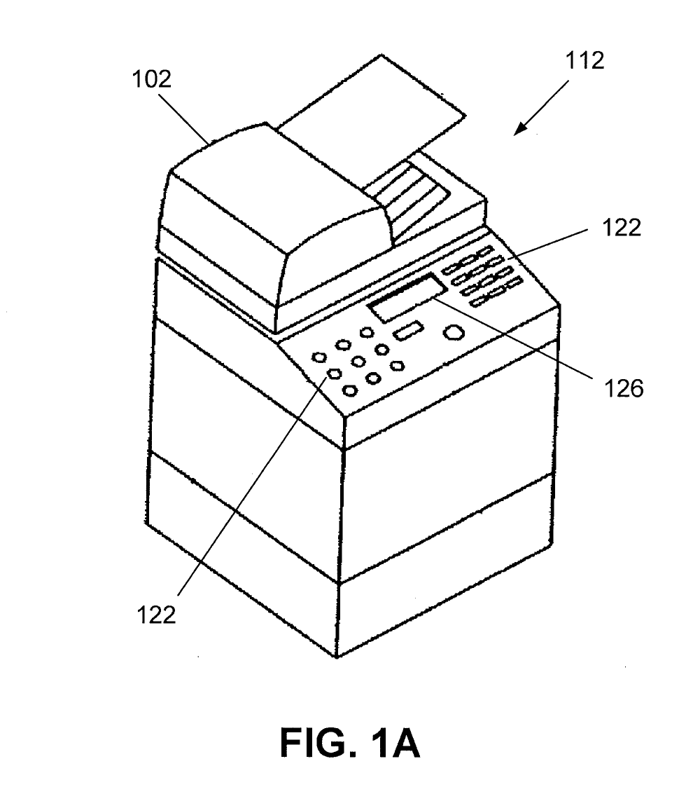

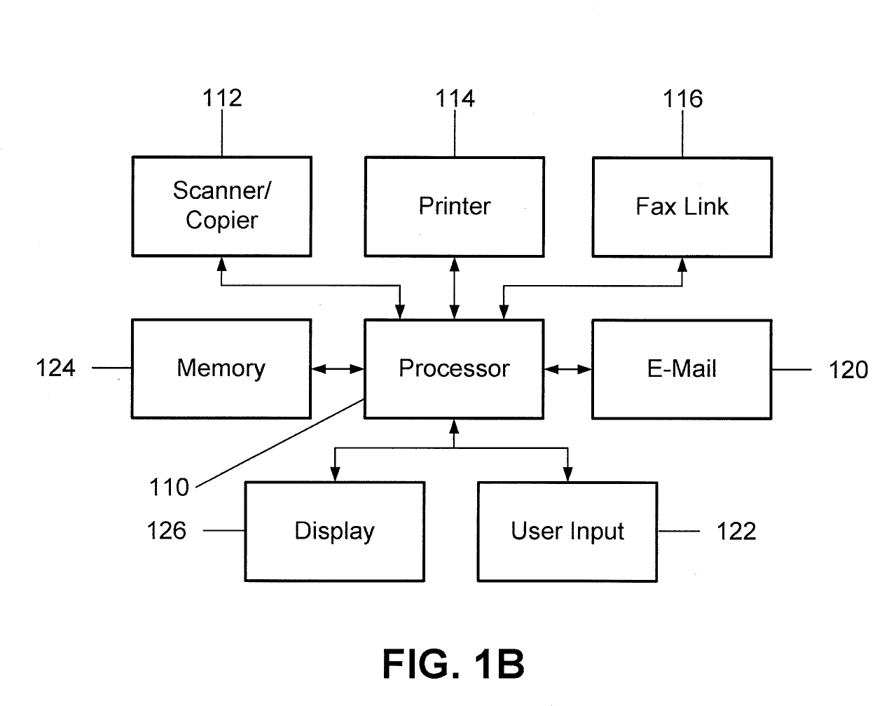

Reference will now be made to the drawings wherein like numerals refer to like parts throughout. As is shown in FIGS. 1A and 1B, the typical multi-function peripheral device (MFP) 102 includes a variety of different inputs and outputs for processing documents. For example, the MFP may include a scanner/copier 112, whereby physical documents can be electronically captured and then reproduced or forwarded to another location. The forwarding can be provided either by a fax link 116 or via email 120. The MFP may also include a printer 114 that can be used to print either a scanned document or can be used to print documents that are being electronically transmitted to the MFP 102 via the various communication links 116, 120. As is also illustrated, a variety of user inputs 122, such as buttons, touch screen menus, or any other known user input, is also provided to the MFP. Further, the MFP also has a display 126 which can be in a variety of different sizes. It will be appreciated that often the user inputs 122 are incorporated into the display 126 in the form of touch screen menus and the like.

The MFP 102 is controlled by one or more processors 110 that receive electronic signals and process the documents according to the user inputs and also according to internal commands in a known manner. The processor 110 further includes one or more memories 124 wherein various documents can be stored along with various other protocols for processing documents. It will be appreciated that the operation of the MFP 102 will permit the MFP 102 to perform any of a number of known functions that are currently implemented by MFP devices.

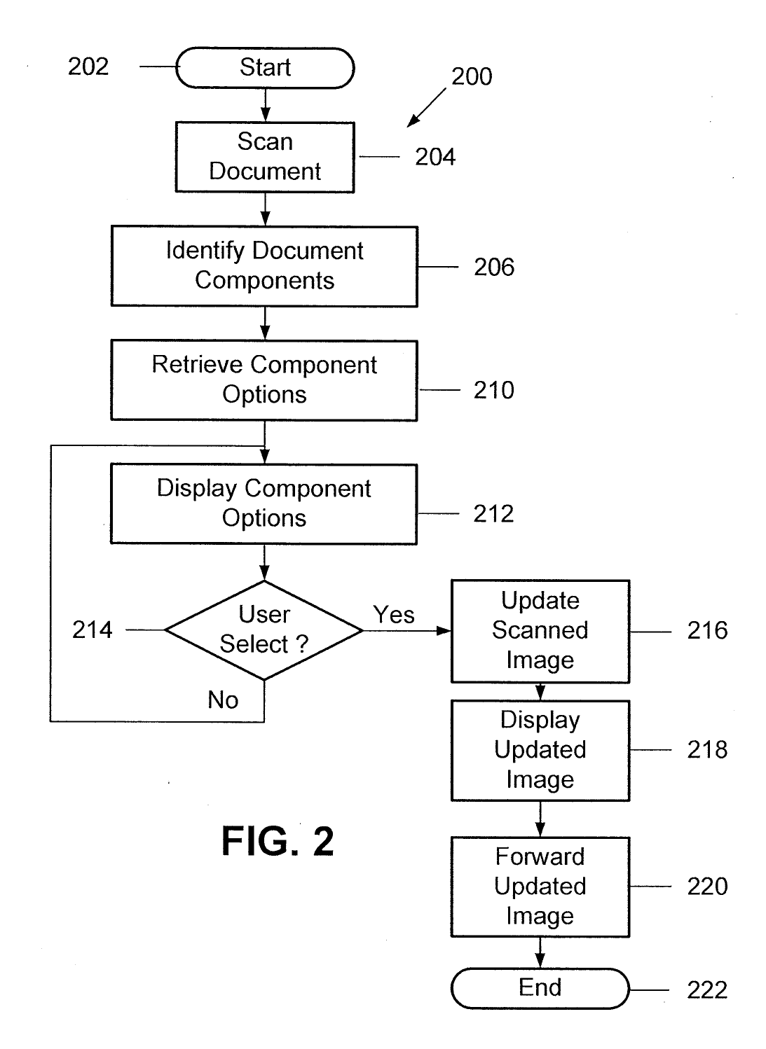

Advantageously, the MFP device 102 of the preferred embodiment is capable of allowing a user to selectively modify a scanned document using the controls of the MFP 102. Thus, the user can modify documents without having to resort to the use of an additional computer. This further allows the user to modify the document and send the document directly in a desired modified state from the MFP device 102. FIG. 2 is an exemplary flow chart illustrating the operation of the MFP 102 as it implements a process whereby a user can modify the document.

From a start state 202, the MFP proceeds to scan the document, in state 204, in a known manner. Generally, the scanning results in an electronic version of the original physical document being captured by the processor 110 in the memory 124 of the MFP 102.

Once the electronic version of the document is captured, the processor 110 then identifies the document components in state 206. The processor 110 is preferably programmed so as to be able to identify a variety of different types of document components. These document components can include such things as photographs, graphs, images, regions of text, and the like.

For each of the different types of document components that are identified by the processor 110, the processor 110 can access, in state, 210 a plurality of different options in the memory 124. The options are, in one implementation, pre-set options whereby the processor 110 will adjust or otherwise modify the document component in accordance with instructions from the user via the input 122 of the MFP 102. Examples of different options for document components includes such things as changing the size of a document component, changing the coloring or contrast or brightness of a particular document component, altering the shape of the particular document component, etc. Options can also include options for multiple document components or for the document in general and can include such things as specifying a particular location to which the document is to be transmitted or identifying a particular file structure or manner in which the document is to be saved. It will be appreciated from the following description that any of a number of different document or document component options can be implemented in this process without departing from the spirit of the present invention.

Once the different document components have been identified in state 206 and the various options have been retrieved in state 210, the options for each of the document components can then be displayed, in state 212, to the user. As will be discussed in greater detail below, the manner in which the document component options are displayed to the user can vary depending upon the display capabilities of the MFP 102.

In one implementation, the MFP 102 is equipped with a very substantial display 126, such that some or all of the document component options can be displayed to the user via the display 126 thereby allowing the user to select various options using the user inputs 122 of the MFP 102. In another implementation, the MFP 102 has a limited or non-existent display such that the options are displayed to the user by printing an image of the document with overlaid options on the printed document. The user can then graphically select various component options and then re-scan the printed page thereby allowing the MFP 102 to modify the electronic version of the document in the manner that will be described in greater detail below.

The MFP 102 determines whether the user has selected particular display component options, in decision state 214, and, if the user has selected different display component options, the MFP 102 then updates the electronic scanned image in state 216 according to the document component option selected by the user. Subsequently, the MFP 102 can optionally display the updated image in state 218 to the user. The display of the updated image can either be in the form of displaying it on the display 126 provided that the display 126 has the capability of rendering the image in sufficient detail or by printing a copy of the updated electronic image for the review of the user.

It will be appreciated that the user can thus approve the updated scanned image or disapprove it prior to the MFP 102 forwarding the updated image to a desired final destination in state 220. Once the document has been forwarded, the processor 110 and the MFP then proceeds to an end state 222. It will be appreciated that the foregoing process 200 allows the user to scan an image and then alter or change or modify the resulting scanned electronic image using the MFP 102. This facilitates the user in being able to send an electronic version of the document to a destination in a desired format without having to use an additional computer system to modify the electronic version of the document.

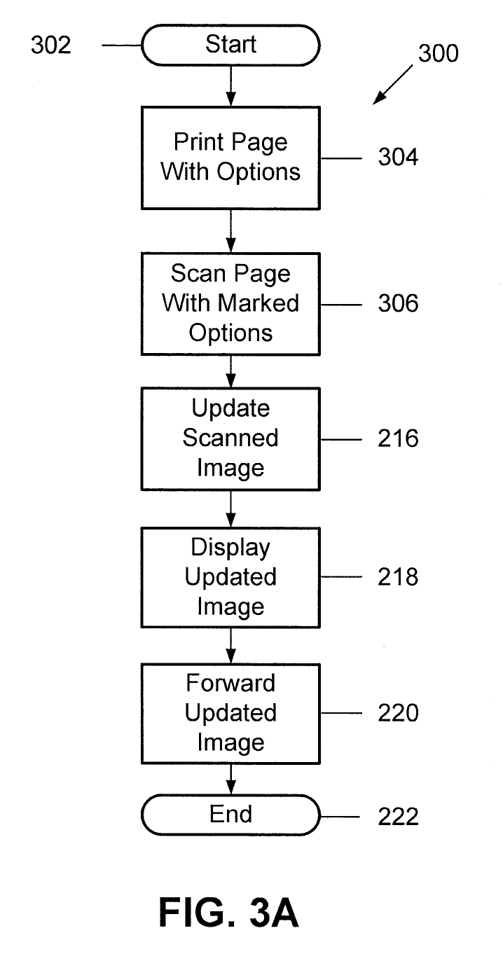

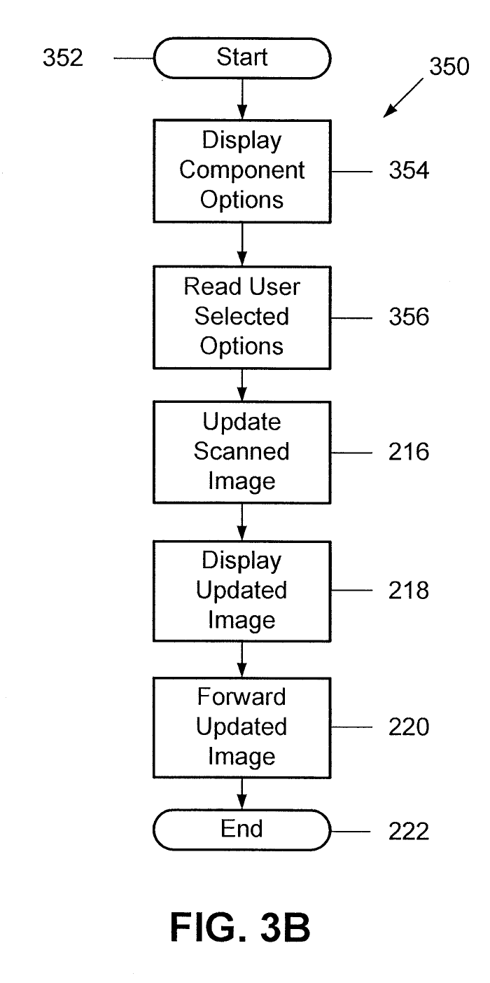

As discussed above, there are a variety of different ways in which the different document component options can be displayed. Referring initially to FIG. 3A, an exemplary process whereby document component options can be displayed using an MFP 102 with a non-existent or limited display 126 is illustrated. In the process 300, the MFP 102 from a start state 302 initially prints a page in state 304 via the printer 114 which has printed document component options on the page. Preferably, the document component options are printed in predefined locations and the user is instructed to select predefined document component options by marking or coloring or otherwise graphically selecting the options on the page. The page is then scanned in state 306 using the scanner 112 so that the resultant image is scanned with the marked document component options. The MFP 102 then proceeds to update the electronic version of the document that was previously scanned and stored in the memory in state 216. The MFP 102 may then optionally display the updated image in state 218, e.g., by printing the modified document, and forward the updated electronic to the final destination in state 220 in the manner that was described above. It will be appreciated that this method of displaying the various document component options and allowing the user to select the various component options is readily adaptable to lower cost MFP devices that have limited display capability.

Referring to FIG. 3B, an alternative manner of displaying the document component options to the user is provided by the process 350. In the process 350, the MFP 102 is equipped with the more elaborate display 122 such that the document component options can be displayed to the user via the display 126 as opposed to printing the options in the manner described above in conjunction with FIG. 3A. In this particular implementation, the MFP 102, from a start state 352, proceeds to display the component options in state 354 on the display 126. The manner in which the options can be displayed on the display 126 can vary greatly without departing from the spirit of the present invention. For example, if the display is sufficiently elaborate, pages of the scanned document can be displayed with various document component options overlaid with each of the various document components. The user can then select the various options either via touch screen or using any of the other user inputs 122. Alternatively, for simpler displays, each of the document components recognized by the processor 110 can be serially provided to the user, often in an abbreviated format, and the user can then select various options for each of the components. The exact implementation of how the document and document components can be displayed to the user via the display 126 can vary greatly depending upon the capability of the display without departing from the present teachings.

The MFP then reads the user's selected options, in state 356, by reading the user inputs 122. Again, the user inputs 122 can comprise buttons that are mounted on the MFP 102, touch screen buttons, or any of a number of other known user input devices that are implemented on MFP devices.

Once the user selected options are received, the MFP 102 then proceeds to update the electronic version of the document stored in memory in state 216 and optionally display the updated image in state 218 and forward the updated image to a final destination in state 220 in the manner described above. Hence, the processes 300, 350 allows for a wide variety of different ways in which a user can modify a scanned document without requiring the user to utilize a separate computer system.

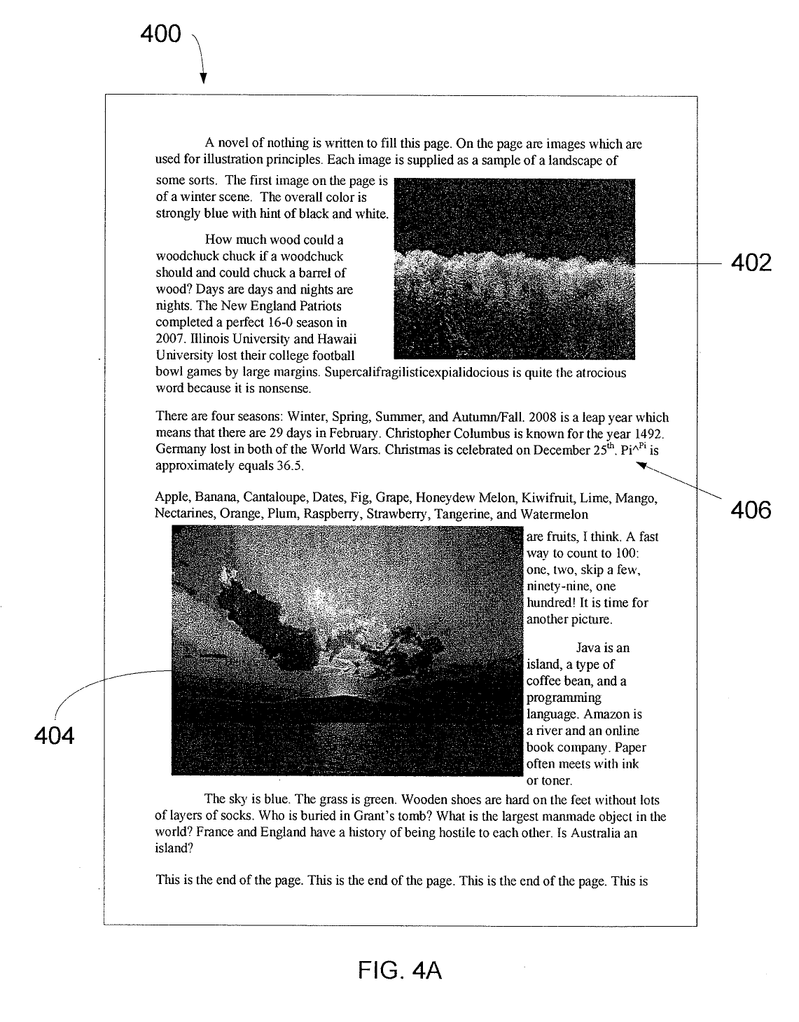

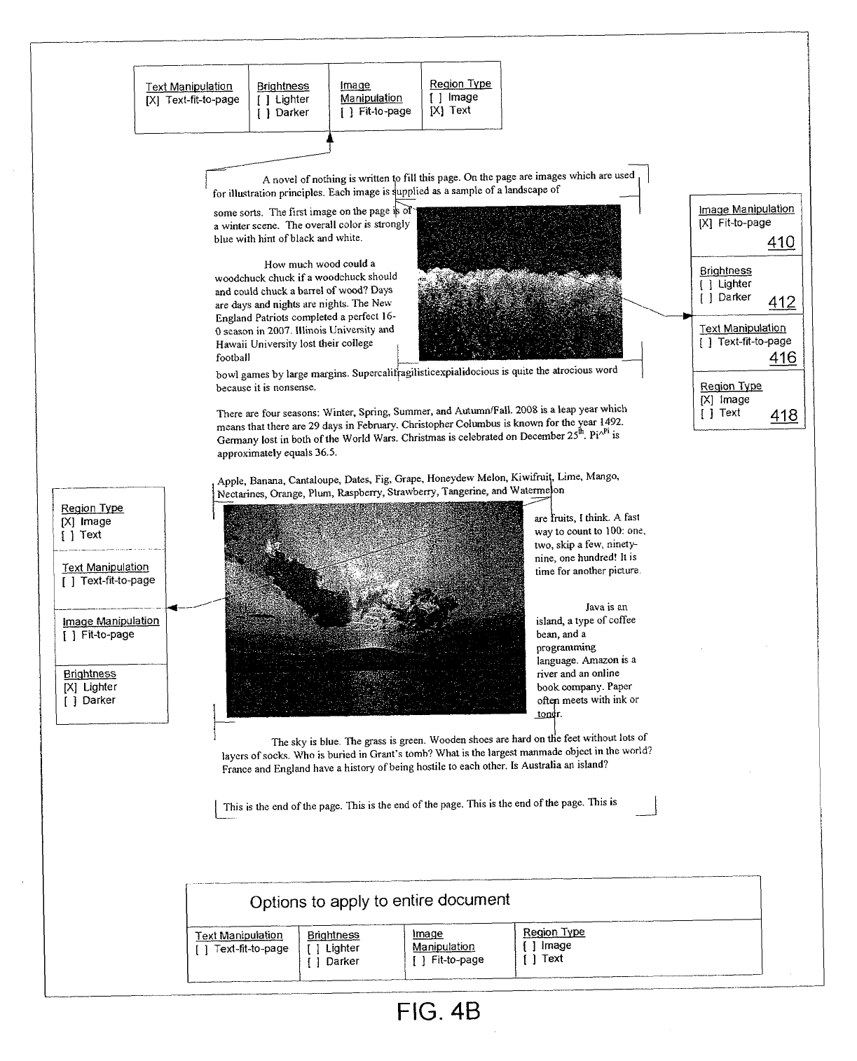

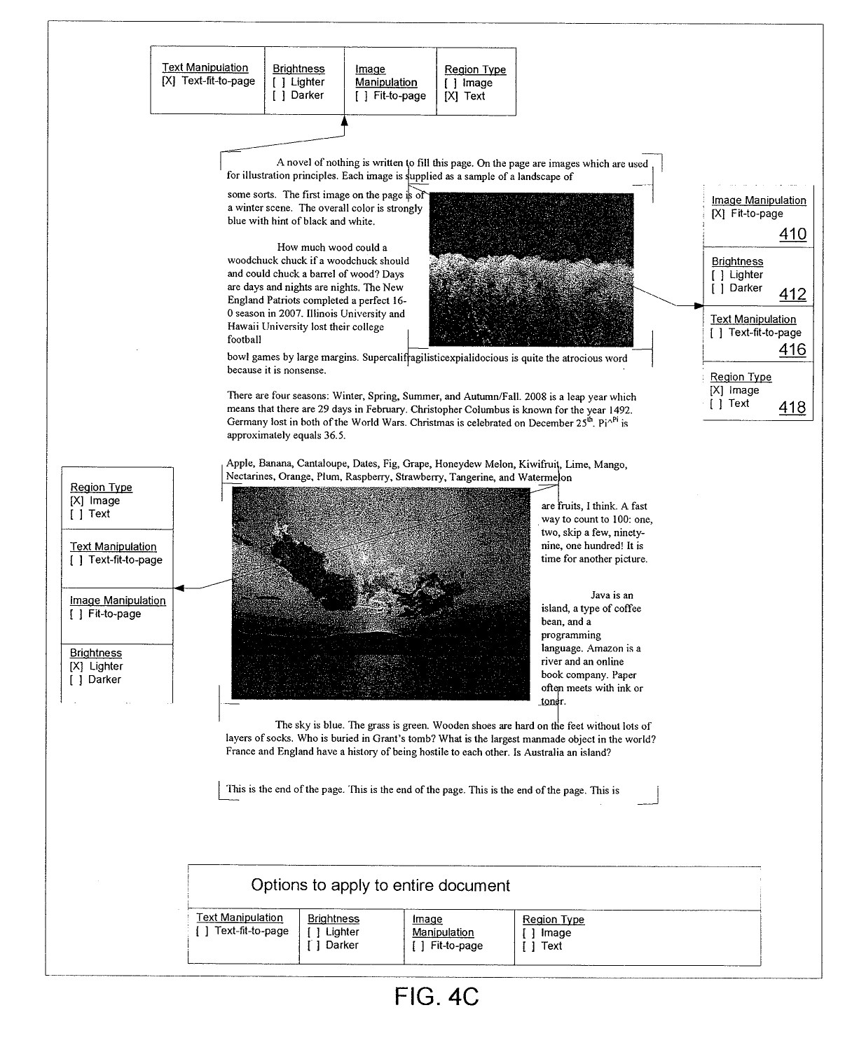

The processes of FIGS. 3A and 3B will now be described in conjunction with the example of FIGS. 4A-4C. FIG. 4A is a graphical representation of a typical document that can be scanned by the MFP device 102. The document, in this particular implementation, comprises at least three separate components. One component is the upper photograph 402. The second component is the lower photograph 404 and the third component comprises the text 406. The MFP 102 is preferably programmed so as to be able to identify images such as the photos 402 and 404 and recognize them as separate document components. Similarly, the MFP 102 is also preferably adapted to be able to recognize the text 406 as at least one document component.

It will be appreciated that the MFP 102 may be programmed so as to be able to recognize subcomponents of the various document components as components in and of themselves. For example, separated sentences of text may be recognized as titles, individual paragraphs may be recognized as separate document components, similarly subcomponents of images, such as photographs, diagrams, and the like, may also be recognized as separate subcomponents for which options may be presented to the user for display.

FIG. 4B provides some exemplary document component options that can be displayed to the user either as a result of the image of FIG. 4B being printed by the MFP in the printer 114 or by the image in FIG. 4B being displayed in some manner to the user via the display 126 in the previously described manner.

As indicated in FIG. 4B, various different options 412-418 may be available for each of the components and these options are generally going to be displayed to the user in such a manner that they correlate to the particular document component.

For example, with respect to each of the document components, options such as image manipulation whereby the document component can be manipulated to fit the page or display options such as brightness whereby the brightness of a particular document component can be either increased or decreased or the like can be implemented as a result of the user selecting the various document component options. As is also shown in FIG. 4B, the component options may also include options that allow the user to select the type of document component. In this example, the component option 418 allows the user to designate that a particular option is either an image or text. The MFP 102 can thus be programmed to provide additional options or do additional processing of the document based upon the user's selection. Again, the image of FIG. 4B can be displayed to the user by printing the image of FIG. 4B or by displaying the image of FIG. 4B or some facsimile thereof via the display 126. As is also illustrated in FIG. 4B, the various options can be subscribed to a variety of different document components and the document components are not necessarily to be limited to particular component types, e.g., images or text, but may also comprise generalize regions of the document 400. Further, there can be document options 430 that can apply to the entire document as opposed to just components. These may include text manipulation or display manipulation or can also include such things as address information or location options, such as moving images to different pages, and the like.

As is illustrated in FIG. 4C, the user has selected various options for particular regions of the document 400. As indicated, the user can do text manipulation such as having the text fit to a page. In this particular exemplary implementation, the processor 110 is adapted to perform an optical character recognition on components of the document that are identified or recognized as text such that a dynamic document component is thus created out of the original scanned component. Similarly, the images can have their appearance altered by lightening the brightness of the image and by sizing the image to fit the page.

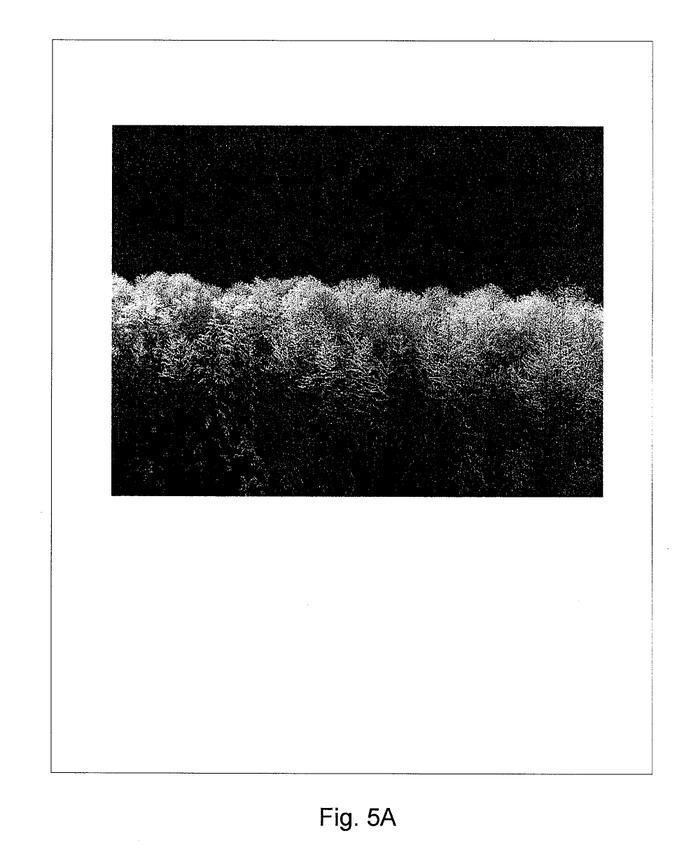

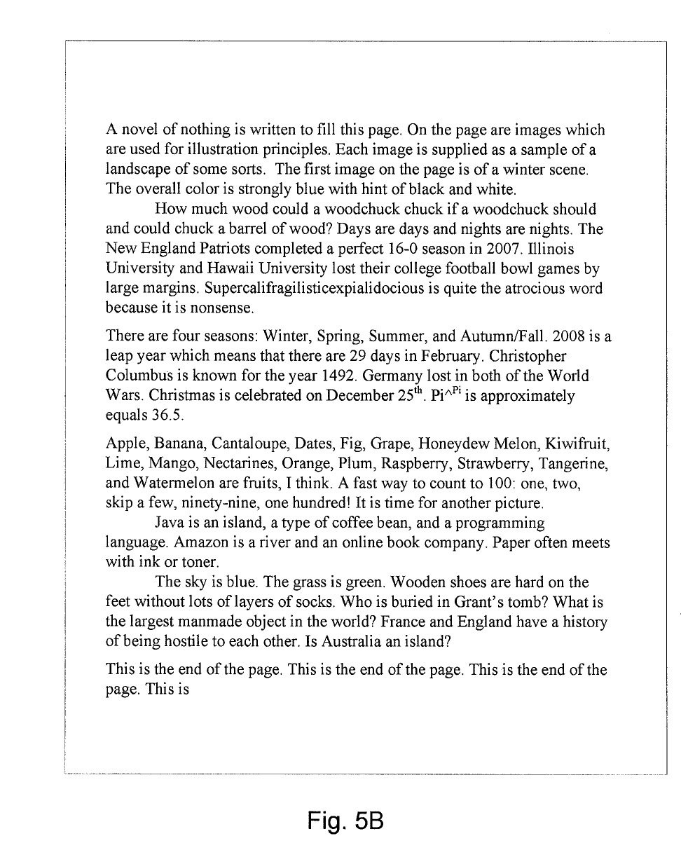

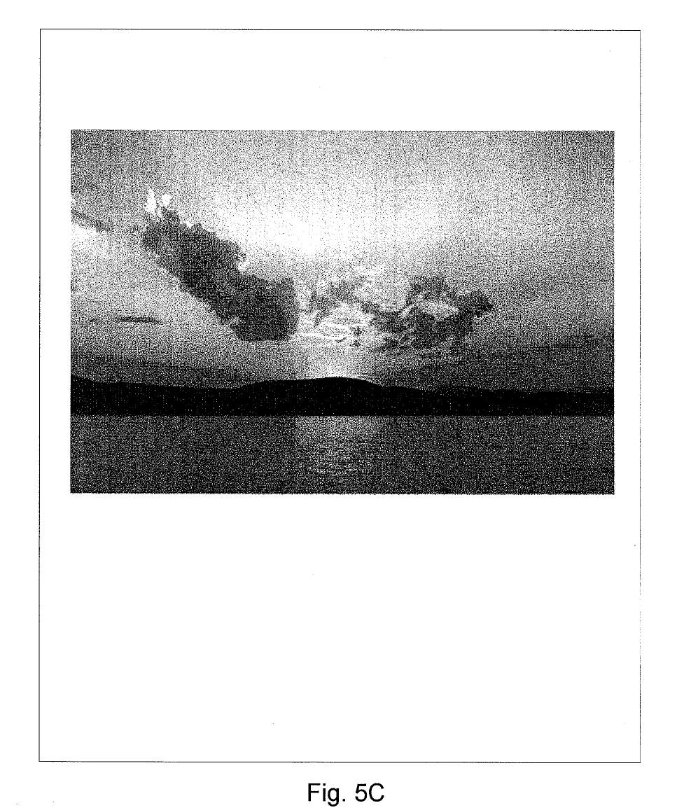

Again, the user can select these particular options by either marking them on the printed paper in the process of FIG. 3A and then rescanning the printed piece of paper or by electronically selecting the option via the inputs 122 in the manner described in conjunction with FIG. 3B. In this exemplary implementation, the text has been identified as text, and one of the images has been selected to fit the page and the other image has been selected to have a lighter brightness characteristic. FIGS. 5A-5C are the resultant document that is created off of the original document. In this implementation, one of the photos is now fitting the page on one page 502. The text is then contained on a second page 504 and a lighter image is presented on a third page 506. Thus, the original image can be processed by the user using the MFP device and the MFP device 102 can then be used to transmit the modified image to a final destination in a more simplified manner.

Although the above disclosed embodiments have shown, described and pointed out the novel features of the invention as applied to the above-disclosed embodiments, it should be understood that various omissions, substitutions and changes in the form of the detail of the device, systems and methods shown, may be made by those skilled in the art without departing from the scope of the present invention. Consequently, the scope of the invention should not be limited to the foregoing description, but should be defined by the appended claims.

What is claimed is:

1. A multifunction peripheral (MFP) device comprising:
a scanner that captures an electronic version of a document; and
a processor that is coupled to the scanner, wherein the processor is adapted to review the electronic version of a document and provide options for modifying the electronic version of the document to a user so that the user can modify the electronic version of the document using the multifunction peripheral device.

2. The MFP device of claim 1, wherein the processor is adapted to identify different components of the document and to induce the display of options to the user for modifying one or more of the different components of the document.

3. The MFP device of claim 2, wherein the processor is adapted to identify images and text as different document components.

4. The MFP device of claim 2, wherein the processor provides the options of: changing the size of one or more of the different components, changing the display characteristics of the one or more different document components, specifying a type of file or destination for the modified electronic version of the document, or changing the display image location.

5. The MFP device of claim 1, further comprising a display, wherein the processor is adapted to display the options for modifying the electronic version of the document to the user via the display.

6. The MFP device of claim 5, wherein the display is sized so that an image of the electronic version of the document can be displayed along with the options for modifying the electronic version of the display.

7. The MFP device of claim 6, further comprising at least one user input that the user can use to select among the options for modifying the electronic version of the display.

8. The MFP device of claim 1, further comprising a printer wherein the processor induces the printer to print a representation of the electronic version of the document with the options for modifying the document also printed on the representation of the electronic version of the document.

9. The MFP device of claim 8, wherein the processor is further adapted to review the printed representation of the electronic version when the user scans the printed representation of the electronic version with the scanner to identify which of the printed options the user has graphically selected so that the processor can modify the electronic version of the document in accordance with the user's selected options.

10. A multifunctional peripheral (MFP) device that scans documents to capture an electronic representation thereof, wherein the multifunctional peripheral device displays to a user options for modifying the electronic representation of the document and wherein the user can select options using the MFP device so that the user can modify the electronic representation of the document using the MFP device.

11. The MFP device of claim 10, wherein the MFP is adapted to identify different components of the document and to induce the display of options to the user for modifying one or more of the different components of the document.

12. The MFP device of claim 11, wherein the MFP device is adapted to identify images and text different document components.

13. The MFP device of claim 11, wherein the MFP device displays the options of changing the size of one or more of the different components, changing the display characteristics of the one or more different document components, specifying a type of file or destination for the modified electronic version of the document, or changing the display image location.

14. The MFP device of claim 10, further comprising a display, wherein the MFP device displays the options for modifying the electronic version of the document to the user via the display.

15. The MFP device of claim 14, wherein the display is sized so that an image of the electronic version of the document can be displayed and the MFP includes inputs that allow the user to select the options for modifying the electronic version of the display.

16. The MFP device of claim 15, further comprising at least one user input that the user can use to select among the options for modifying the electronic version of the display.

17. The MFP device of claim 1, further comprising a printer that prints a representation of the electronic version of the document with the options for modifying the document also printed on the representation of the electronic version of the document.

18. The MFP device of claim 17, wherein the MFP device reviews the printed representation of the electronic version when the user scans the printed representation of the electronic version with the MFP device to identify which of the printed options the user has graphically selected so that the MFP device can modify the electronic version of the document in accordance with the user's selected options.

19. A method of scanning a document comprising:
scanning a physical document with a multi-functional peripheral (MFP) device to obtain an electronic version thereof,
displaying options for modifying the electronic version of the document to a user via the MFP; and
enabling the user to modify the electronic version of the document using the MFP device.

20. The method of claim 19 further comprising identifying different components of the document and displaying modification options for each of the identified components.

21. The method of claim 20, wherein identifying the different components comprise identifying images and text components of the document.

22. The method of claim 21, wherein displaying options include displaying options to adjust the size or display of the different components.

23. The method of claim 19, wherein displaying different options comprises displaying the electronic version of the document on an electronic display along with the modification options.

24. The method of claim 23, wherein enabling the user to modify the electronic version of the document comprises allowing the user to select modification options via input controls on the MFP device.

25. The method of claim 19, wherein displaying different options comprises printing a representation of the electronic representation of the document with the options being printed on the printed document.

26. The method of claim 25, wherein enabling a user to modify the electronic version of the document comprises:
graphically marking the printed options on the printed document;
scanning the printed document with the graphically marked printed options to obtain an electronic representation of the printed document with the graphically marked printed options;
identifying the graphically marked printed options in the electronic representation; and
modifying the electronic representation of the originally scanned documents in accordance with the identified graphically marked printed options.
